(19) United States
(12) Patent Application Publication
(10) Pub. No.: US 2026/0183772 A1
(43) Pub. Date: Jul. 2, 2026

(54) FOOD GRINDER WITH SHARP-EDGED AUGER

(71) Applicant: URI KANIEL, Netanya (IL)

(72) Inventor: URI KANIEL, Netanya (IL)

(21) Appl. No.: 19/431,241

(22) Filed: Dec. 23, 2025

Related U.S. Application Data
(60) Provisional application No. 63/740,477, filed on Dec. 31, 2024.

(51) Int. Cl. A47J 43/07; A22C 17/00; A23P 30/20

(52) U.S. Cl. CPC B02C 18/30

(57) ABSTRACT

A grinder for grinding meat and vegetables, made from three or fewer parts includes a hollow first tube integrally joined substantially perpendicularly to a hollow second tube at a junction which may be sharp edged and which is defined by a cutout on a top of the first tube adjoining an open end of the second tube. A wall of a distal portion of the first tube has carved therethrough apertures to allow ground food to be extruded. The apertures may have a sharp edge. An auger in the first tube has sharp-edged spiral twists and is configured to move within the hollow first tube. The junction of the tubes may have a sharp edge and/or a sharp-edged projection. The distal portion of the first tube is a modular piece that can be replaced so as to vary a diameter or a taper angle of the apertures.

### FIELD OF THE INVENTION

The invention is in the field of food grinders and pertains to a food and/or meat grinder with an auger having a special blade and/or a housing having special cutting edges.

### BACKGROUND

Versatility is a desirable feature for food grinders. Currently, food grinders tend to be either electric or manual. In many cases, the food grinder has many moving parts and is not easy to manufacture.

### SUMMARY OF THE EMBODIMENTS

One embodiment is a food grinder for grinding meat and vegetables, comprising:
a housing that includes a hollow first tube integrally joined substantially perpendicularly to a hollow second tube at a junction defined by a cutout on a top of the first tube adjoining an open end of the second tube,
wherein a wall of a distal portion of the first tube has carved therethrough a series of apertures that are configured to allow ground food to be extruded through the first tube; and
an auger having sharp-edged spiral twists and configured to move within the hollow first tube.

In some embodiments, the junction comprises a sharp 90 degree edge.

In some embodiments, the junction comprises a sharp-edged projection that extends into a hollow of the second tube.

In some embodiments, the distal portion of the first tube is a modular piece that can be replaced so as to vary a diameter or a taper angle of the apertures.

In some embodiments, the grinder is made of a total of two parts.

In some embodiments, the grinder is made of a total of three parts.

In some embodiments, the grinder is made of three or fewer parts.

In some embodiments, the apertures are evenly spaced.

In some embodiments, each of the apertures comprises a shape that is substantially a truncated cone. In some embodiments, a base of the cone adjoins an outer wall of the first tube.

In some embodiments, the first tube and the second tube meet to form an L-shape.

Another embodiment is a food grinder, comprising:
a housing including (a) an inlet tube and (b) a grinding and outlet tube, that meet at a substantially L-shaped junction, the junction having a sharp edge; and
an auger having bladed spiral twists and configured to move within the hollow first tube,
   wherein the grinding and outlet tube has a perforated portion.

In some embodiments, the perforated portion is removable so as to vary a diameter or a taper angle of apertures in the perforated portion.

In some embodiments, each of the apertures comprises a shape that is substantially a truncated cone and wherein an inner end of the apertures comprises a sharp edge. IN some embodiments, a base of the truncated cone adjoins an outer wall of the grinding and outlet tube.

In some embodiments, the grinder is made of a total of two parts.

In some embodiments, the grinder is made of a total of three parts.

In some embodiments, the grinder is made of three or fewer parts.

In some embodiments, the junction comprises a sharp 90 degree edge. In some embodiments, the junction comprises a sharp-edged projection that extends into a hollow of the tubular inlet.

### BRIEF DESCRIPTION OF THE DRAWINGS

Various embodiments are herein described, by way of example only, with reference to the accompanying drawings, wherein:

FIG. 1 is a perspective view of the meat grinder, in accordance with one embodiment;

FIG. 2 is a partial sectional view of the housing revealing internal elements of the housing, in accordance with one embodiment;

FIG. 3A is a top view of the first tube of the housing showing the sharp-edged junction at which the first tube meets the second tube and showing the auger therein, in accordance with one embodiment;

FIG. 3B is a sectional view taken along line 3B-3B of FIG. 1, in accordance with one embodiment;

FIG. 3C is a sectional view that is an alternative to FIG. 3B and showing a sharp projecting edge, in accordance with one embodiment;

FIG. 4 is a front view of an auger of a food grinder, in accordance with one embodiment;

FIG. 5 is a left end view of the auger of FIG. 4, in accordance with one embodiment;

FIG. 6 is a right end view of the auger of FIG. 4, in accordance with one embodiment;

FIG. 7 is a bottom view of the auger of FIG. 4, in accordance with one embodiment;

FIG. 8 is a bottom view of the first tube of the housing of the food grinder, in accordance with one embodiment;

FIG. 9 is a front view of the first tube of the housing of the food grinder, in accordance with one embodiment;

FIG. 10 is a front view of the housing of the food grinder, in accordance with one embodiment;

FIG. 11 is a left end view of the food grinder, in accordance with one embodiment;

FIG. 12 is a side view from the rear of the food grinder, in accordance with one embodiment;

FIG. 13A is a perspective view from the top and side of the housing of the food grinder, in accordance with one embodiment;

FIG. 13B is a top and front view of the auger highlighting the extra sharp edge at the distal end of the auger, in accordance with one embodiment;

FIG. 13C is a perspective view of the housing from the front and side showing the apertures, in accordance with one embodiment;

FIG. 14 is a partial sectional view of the housing together with the auger, in accordance with one embodiment; and

FIG. 15 is a top view of the auger, in accordance with one embodiment.

### DETAILED DESCRIPTION OF THE EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

Prior art food grinder have many moving parts. Applicant has discovered a structural configuration of a meat or other food grinder that is simpler to manufacture, easy to clean, more efficient at grinding and in certain embodiments has many other advantages that are described below.

In some embodiments, the food and meat grinder is made from metal or strong and durable plastic or a combination of both. For grinding meat, for example, the grinder may be made of metal and even strong and may be made of hard durable plastic special for contact with food that is suitable for vegetables and soft food.

The grinder, in some embodiments, not only has a minimum of total parts (no more than three) but has many areas (two, three or four) of sharp edges for more efficient cutting of meat and other food.

The principles and operation of a Food Grinder With a Sharp-Edged Auger may be better understood with reference to the drawings and the accompanying description.

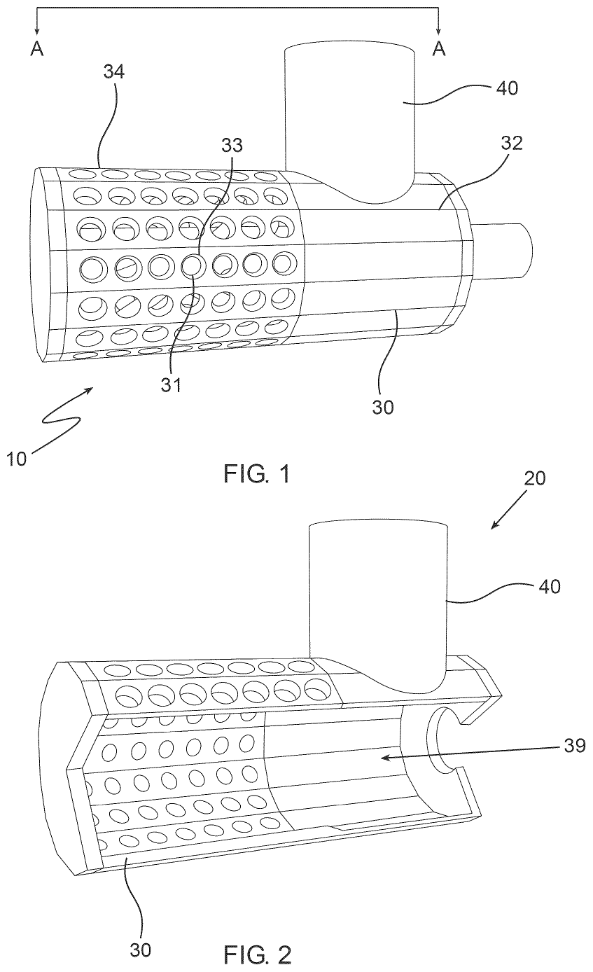

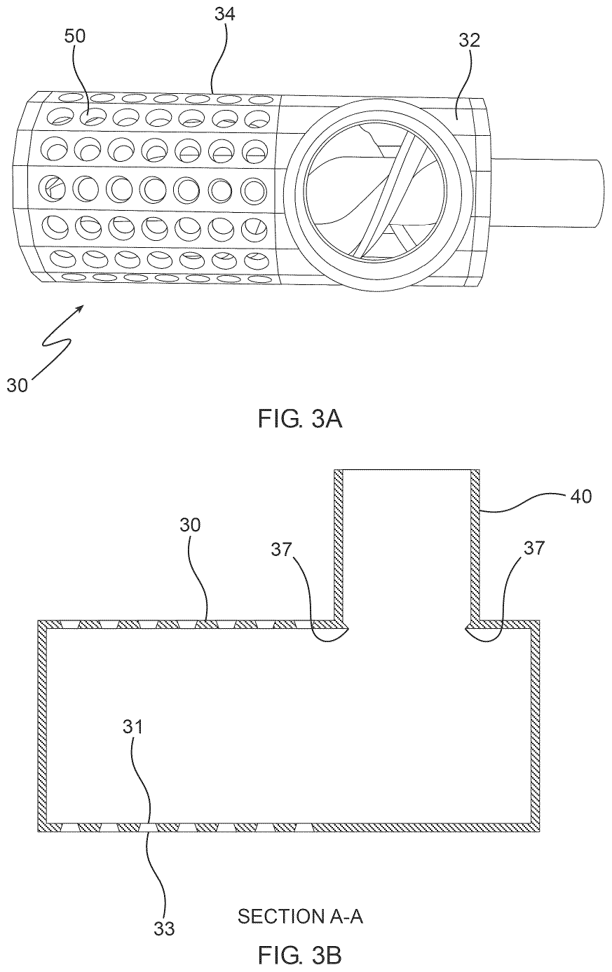

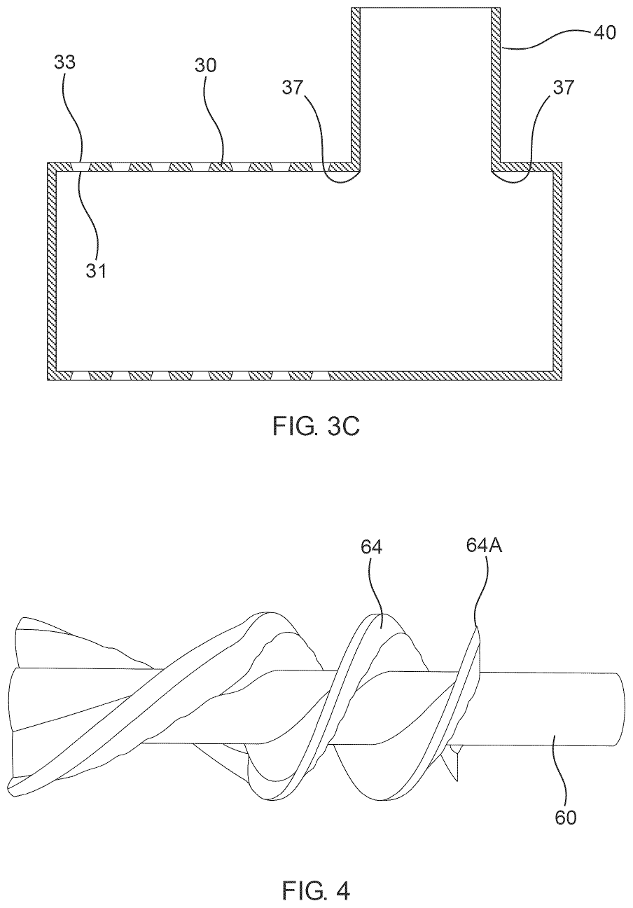

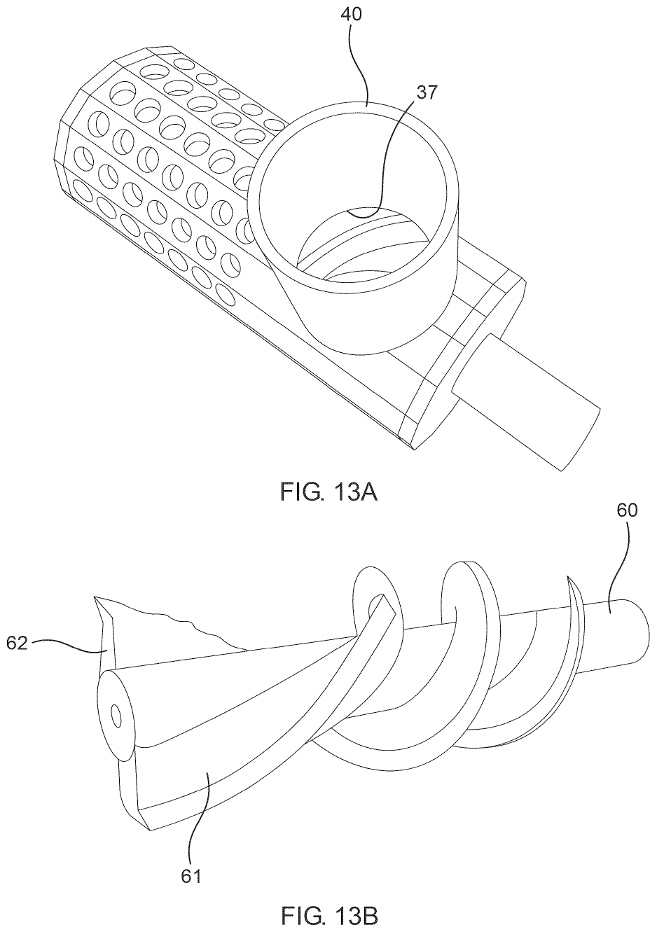

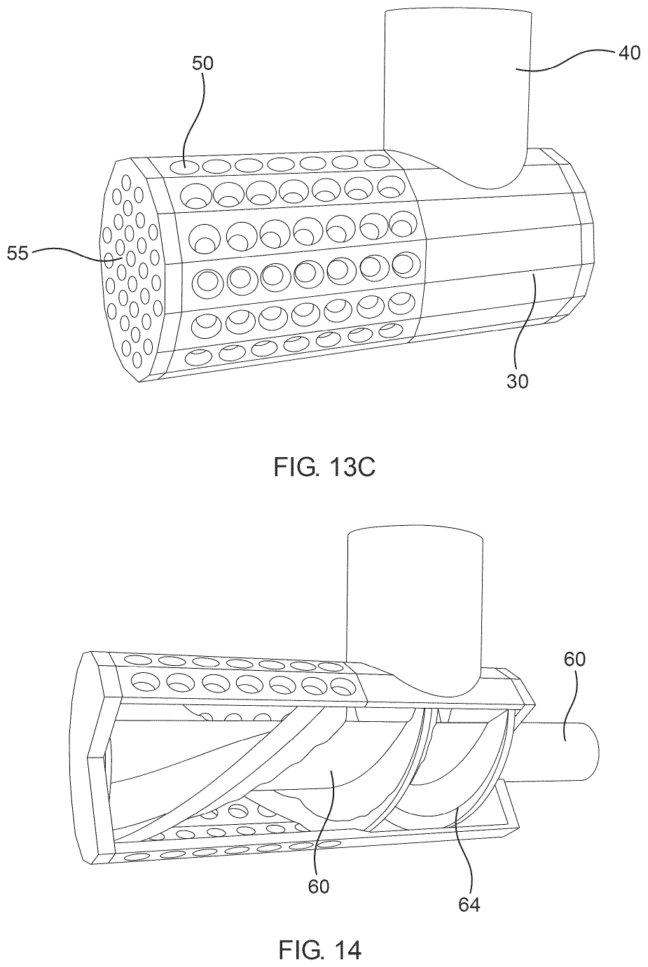

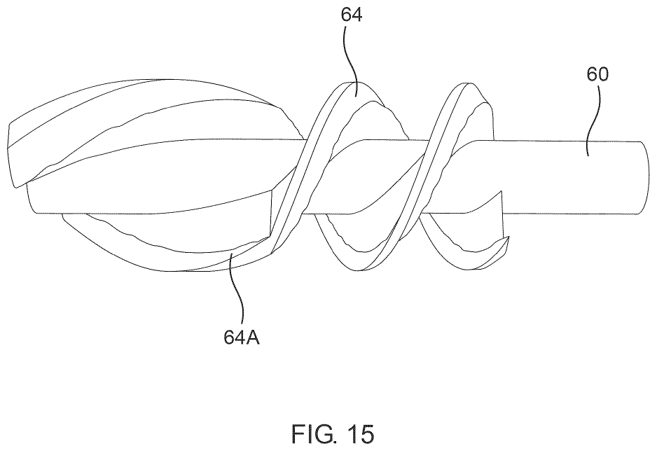

In one embodiment, a food grinder 10 (FIG. 1) is for grinding meat and vegetables. As shown in FIG. 2, food grinder 10 comprises a housing 20 that includes a hollow first tube 30. In use, the hollow first tube 30 is configured to be in a horizontal position. The first tube 30 is integrally joined substantially perpendicularly to a hollow second tube 40 for example at a junction defined by a cutout on a top of the first tube 30 adjoining an open end 41 of the second tube 40, as can be understood from FIG. 3 and FIG. 13A. The second tube 40 is configured to be maintained in a vertical position during use of the grinder 10. As shown in FIG. 1, first tube 30 and the second tube 40 meet to join so as to substantially be an L-shape.

As seen from FIG. 3, the first tube 30 has along its length a proximal portion 32 at which the first tube joins integrally with the second tube 40. In addition, the first tube 30 has along its length a distal portion 34 into which may have carved therethrough a series of apertures 50 (or perforations 50) that are configured to allow ground food to be extruded through the first tube 30 as a result of the grinding process that occurs in the first tube 30. Another name for the first tube 30 is the grinding and extrusion tube 30 or the grinding and outlet tube 30.

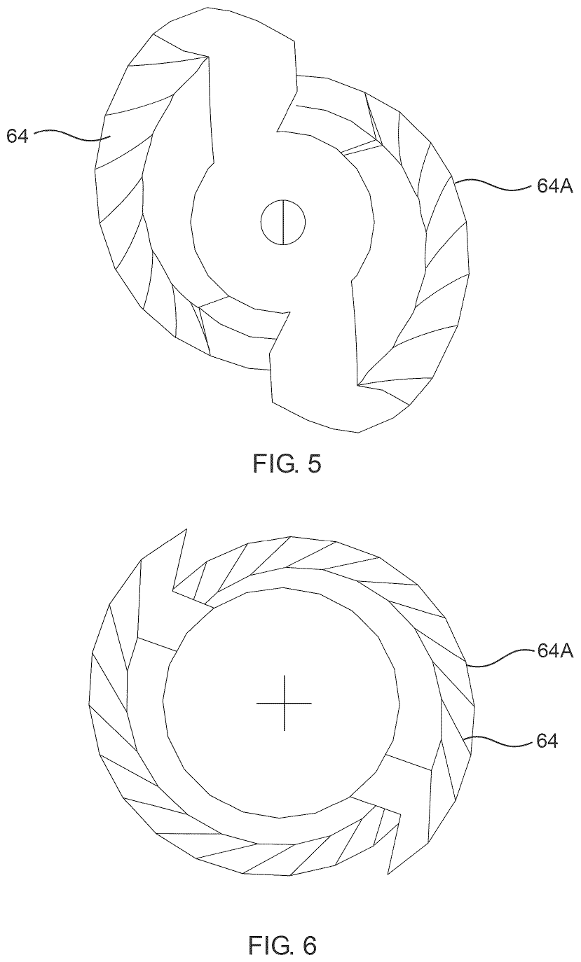

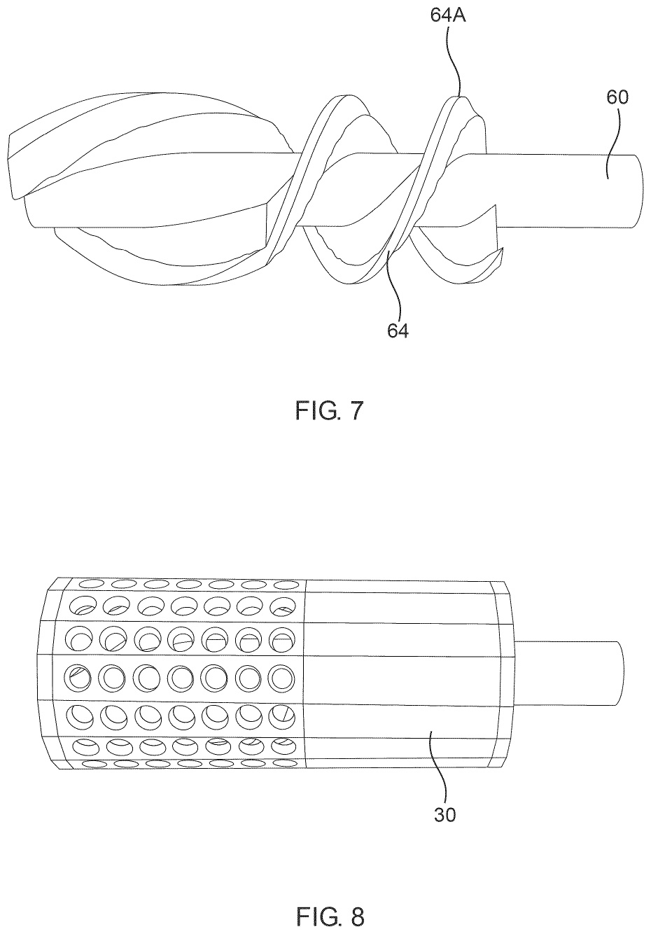

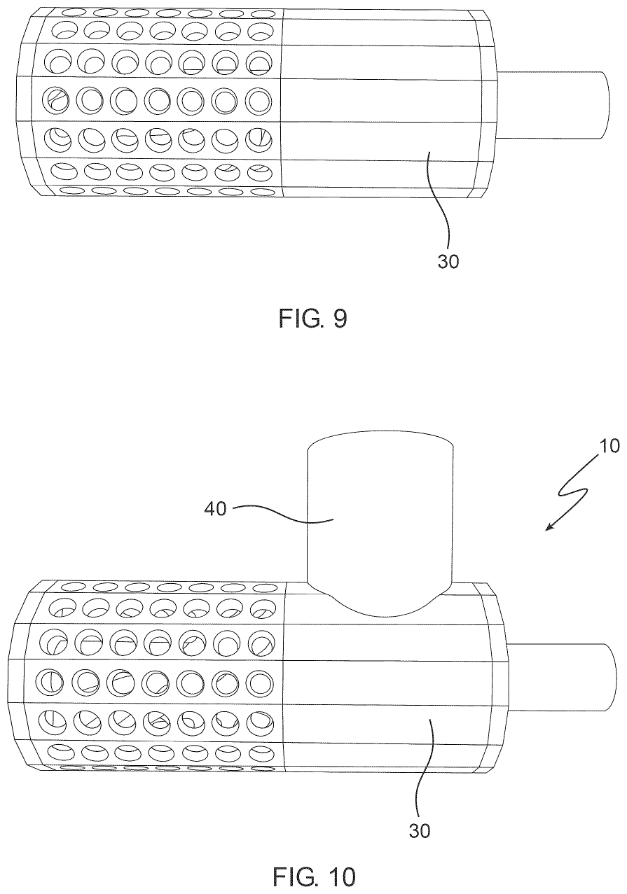

As shown in FIG. 4, grinder 10 also includes an auger 60 that is configured to move longitudinally within the first tube 30 to effectuate the grinding by the grinder 10. The auger 60 may have a cutting lip at a distal end 62 of the auger. Auger 60 has spiral twists 64 which may actually be comprised one continuous spiral along the length of the auger 60. The spiral twists 64 may have sharp edges 64A (FIG. 4, FIG. 5, FIG. 6, FIG. 7) for improving the grinding the meat or other food. In some embodiments, the sharp edges 64A of the spirals of the auger may be slightly serrated, to make the cutting more effective.

The auger 60 is configured to move within the hollow first tube 30 for example as a result of being rotated by an axle (not shown) connected to an external drive (not shown).

In addition to the sharp edges 64a of the spiral twists 64 of the auger 60, in certain embodiments, the junction at which the first tube 30 meets the second tube 40 itself comprises a sharp edge 37, as seen from FIG. 3A. As a result, there is an initial grinding of the food, such as meat or vegetables, that occurs is using grinder 10. This initial grinding makes the later grinding by the sharp edges of the auger 60 that much easier and more efficient. The angles of the spirals 64 may be varied in accordance with different product lines for different precise uses (different types of food being ground). Accordingly, the angle may differ from that shown in FIG. 4, 7, 14.

In addition, as shown in FIG. 13B, the distal end 61 of the auger 60 may be formed in some embodiments with an additional sharp edge 62, such as a cutting lip 62.

FIG. 2 shows internal elements of the first tube 30 in some embodiments including food transport slots 39 and conical apertures 50. The food transport slots 39, which may be implemented in the form of grooves, are configured to move the meat or other food forward (toward the distal portion of the first tube 30 where there are apertures 50), although these slots are not a requirement.

In some embodiments, the entire distal portion 32 of the first tube 30 is a modular piece that can be removed and replaced. This allows for a variety of distal portions 32 of the first tube 30 to be available for connection to the grinder 10, each with differently sized apertures 50, for example aperture 50 with differently sized diameters. As a result, portion of the first tube 30 having the series of apertures, sometimes called a mesh, can be pulled out and replaced so that the same grinder 10 can have one mode for fine grinding and a second mode for coarse grinding of the food. The mesh can also be made of one solid piece.

In addition, the whole first tube 30 may be replaced so as to vary its length (and in some embodiments and/or to vary the diameter of the first tube, although this may require varying the diameter of the second tube in some embodiments). As shown in FIG. 13C, optionally, apertures 50 may be added to a cover 55 (FIG. 13C) at the distal end of the first tube 30.

As shown in FIG. 10, the apertures 50 may be evenly spaced, although this is not a requirement.

As seen from FIG. 1-3, 12, in some embodiments each of the apertures comprises a shape that is substantially a truncated cone, wherein a base of the cone adjoins an outer wall of the first tube. In embodiments in which the outer part of the apertures 50 in the metal of the first tube 30 have a conical structure on the outside, this allows the minced meat or other food to exit easily. It also facilitates easy cleaning.

In use, the final part of the spiral 64 of the auger 60 performs both pushing the meat (or vegetables or other food) into the apertures 50 and quickly cutting the meat (or other food) that adheres to the apertures 50 from the pressure of the moving auger 60. The narrow opening of the apertures (which apertures 50 may be conical), also prevents the meat or other food from going backward into the first tube 30 again after the food is extruded out of the first tube 40. This provides the further advantage of simpler construction in that there is no need for push slots near the apertures. In fact, the only place where the option of push slots (not shown) is implemented in some embodiments is in the proximal portion 32 or rear portion 32 of the first tube 30 to facilitate pushing the food forward after it leaves the second tube 40.

Another embodiment is a food grinder 10, comprising a housing 20 including an inlet tube 40 so-called because the food is placed into an inlet at the top of the inlet tube 40 to start the grinding process and to reach the area where the food will eventually be ground. Housing 20 also comprises a grinding and outlet tube 30, that meets the inlet tube 40 at a junction.

In some embodiments, as shown in FIG. 3B and FIG. 3C, the junction has a sharp edge 37. This provides a further source of grinding the food and speeds up the grinding process, making it more efficient. In FIG. C the sharp edge is the sharp right angle of the junction. In FIG. 3B the sharp edge at the junction includes a sharp edge 37 projecting horizontally.

In this embodiment, food grinder 10 also comprises an auger 60 having spiral twists 64 that may comprise sharp edges 64A or blades 64A.

The grinding and outlet tube 30 may have a perforated portion 34.

In some embodiments, the perforated portion 34 (FIG. 3A) is removable from the rest of the grinding and outlet tube 30 (or in some cases the entire grinding and outlet tube 30 is removable from the inlet tube 40) so as to vary a diameter (and/or tapering angle) of apertures 50 in the perforated portion (or other dimensions of the first tube such as its length or diameter. This way, for example, a user is able to create pieces of meat that are large or pieces of meat that are small. The same with other food.

These apertures 50 may be conical in shape and may comprise a shape that is substantially a truncated cone, whose base adjoins an outer wall of the grinding and outlet tube 30. This is best seen from the sectional views of FIG. 3B and FIG. 3C, and FIG. 1, where the inner aperture end 31 where the aperture 50 meets the inner wall surface of tube 30 is narrower than the outer aperture end 33 where the aperture 50 meets the outer wall surface of tube 30.

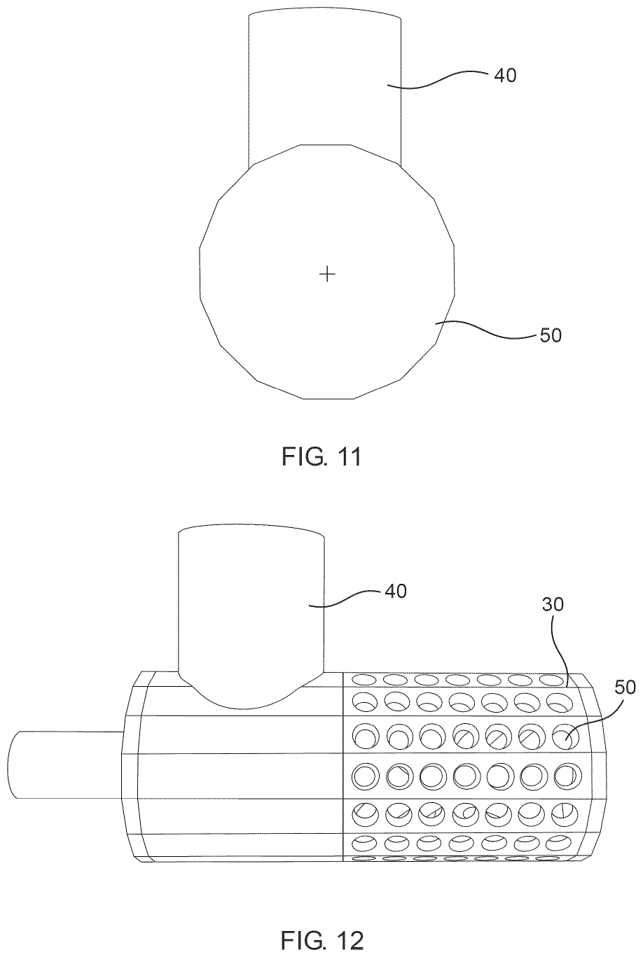

It should be understood that although FIG. 11 and other drawings show the perimeter of the grinding and outer tube 30 as having multiple facades (as to being round), the grinding and outer tube 30 may in fact be substantially cylindrical with a substantially round perimeter. Accordingly, the depiction of multiple facades on the outer surface of the grinding and outer tube 30 is illustrative and should not be construed as a limitation in any embodiment herein.

In any embodiment in which the apertures 50 of grinding and outlet tube 30 are conical, the exact angle of taper of the conical shape of apertures 50 of the tube 30 is not intended to be exactly as drawn in the figures. Rather a range of possible angle are encompassed by the invention. In some embodiments, the angle of taper of apertures 50 is 20 degrees. In some embodiments, their angle of taper is 30 degrees. In some embodiments, their angle of taper is 40 degrees. In some embodiments, their angle of taper is 50 degrees. In some embodiments, their angle of taper is 30-50 degrees, or 20-40 degrees. In some embodiments, the angle of taper is 20-50 degrees.

In certain embodiments, one of the advantages of the food grinder 10 is that it is made of only two pieces, the housing 20 and the auger 60. In some other embodiments, it is made of up to three parts or a total of three parts. Furthermore, the grinder 10 has only one moving part, namely the auger 60. In traditional grinders, there are typically at least five parts.

Another advantage is the combination of the sharpness of the spiral edges 64A of the auger 60 and the inner sharp edge 37 (FIG. 3B) at the junction where the first tube 30 and the second tube 40 meet. In certain embodiments, the perforations 50 are conical in a manner such that the inner end of the apertures 31 of the tube 30 provides a further sharp edge to cut the food as it exits the tube 30. Accordingly, in these versions, grinder 10 has yet another area in which a separate sharp edge is provided.

In some embodiments, the auger 60, the junction 37 and the apertures 50 each provide an area of grinder 10 having sharp edge(s). This provides an advantage in that with only 3 total parts in the grinder 10, the grinder 10 is versatile enough to provide at least an equal number of areas having a sharp edge for grinding or cutting the food. In some cases, there are 4 such areas since the distal end 62 of the auger 60 may also have a cutting lip that has a sharp edge for cutting the food.

In addition, in contrast to the prior art, in some embodiments, grinder 10 contains no rotating knife and no meat caught and straining the engine. The meat cannot be caught like in traditional grinders because there is no separate knife at the distal end of the auger 60, where the caught meat would cause a lot of extra effort being placed on the motor (not shown) that is connected to the auger 60. In traditional grinders it is therefore necessary to have the added option of rotating the auger in reverse to release stuck meat, which causes a lot of frustration. This is entirely unnecessary in the grinder 10 herein.

Furthermore, there is less of a need for a stomper because the spiral shape of the blades of the auger together with the extra sharp edges 64 pulls in the food.

The combination of the various sharp edges 64, 37 results in the meat being cut roughly as soon as it enters, therefore saving the need to cut the meat into small cubes before inserting it.

As a result, the grinder 10 has a high level of efficiency and produces high quality food processing in a minimal amount of time.

Grinder 10 may be manufactured by machining since the tubes 30, 40 may be substantially cylindrical, symmetrical and smooth.

The auger 60 is configured to fit snugly within the first tube 30. This may be accomplished by having the outer diameter of the spirals 64 be about the same magnitude as the inner diameter of the walls of the first tube 30. In some embodiments, the outer diameter of the spirals 64 of the auger 60 is very slightly smaller than the inner diameter of the inner wall of the first tube 30 such that the auger 60 fits snugly exactly into the inside of the first tube 30 cylinder with a minimal clearance

Grinder 10 is suitable for manual processing by adding a handle (not shown) to turn the external axle or external drive connected to the proximal end of the auger 60, as well as for connection to electric machine for example an electric motor that drives an axle connected to the proximal end of the auger 60.

The grinder 10 may be for both home and industrial use.

The grinder 10, especially the first tube 30, can be also made from a machined stainless steel especially the first tube 30, which is also called the perforated tube.

In one option, most of the auger 60 is made from Delrin, which is a hard food-grade plastic. In that case, the spiral edges 64 of the auger 60 comprise stainless steel or other sharp metal edges 64A that function as a knife. Furthermore, in that case, the auger 60 may also have a metal shaft in the middle of the diameter of the auger 60, inward of the plastic piece, that is attached to the grinder 10.

While the invention has been described with respect to a limited number of embodiments, it will be appreciated that many variations, modifications and other applications of the invention may be made. Therefore, the claimed invention, as recited in the claims that follow, is not limited to the embodiments described herein.

What is claimed is:

1. A food grinder for grinding meat and vegetables, comprising:
a housing that includes a hollow first tube integrally joined substantially perpendicularly to a hollow second tube at a junction defined by a cutout on a top of the first tube adjoining an open end of the second tube,
wherein a wall of a distal portion of the first tube has carved therethrough a series of apertures that are configured to allow ground food to be extruded through the first tube; and
an auger having sharp-edged spiral twists and configured to move within the hollow first tube.

2. The grinder of claim 1, wherein the junction comprises a sharp 90 degree edge.

3. The grinder of claim 1, wherein the junction comprises a sharp-edged projection that extends into a hollow of the second tube.

4. The grinder of claim 1, wherein the distal portion of the first tube is a modular piece that can be replaced so as to vary a diameter or a taper angle of the apertures.

5. The grinder of claim 1, wherein the grinder is made of a total of two parts.

6. The grinder of claim 1, wherein the grinder is made of a total of three parts.

7. The grinder of claim 1, wherein the grinder is made of three or fewer parts.

8. The grinder of claim 1, wherein the apertures are evenly spaced.

9. The grinder of claim 1, wherein each of the apertures comprises a shape that is substantially a truncated cone.

10. The grinder of claim 9, wherein a base of the cone adjoins an outer wall of the first tube.

11. The grinder of claim 1, wherein the first tube and the second tube meet to form an L-shape.

12. A food grinder, comprising:
a housing including (a) an inlet tube and (b) a grinding and outlet tube, that meet at a substantially L-shaped junction, the junction having a sharp edge; and
an auger having bladed spiral twists and configured to move within the hollow first tube,
wherein the grinding and outlet tube has a perforated portion.

13. The grinder of claim 12, wherein the perforated portion is removable so as to vary a diameter or a taper angle of apertures in the perforated portion.

14. The grinder of claim 12, wherein each of the apertures comprises a shape that is substantially a truncated cone and wherein an inner end of the apertures comprises a sharp edge.

15. The grinder of claim 14, wherein a base of the truncated cone adjoins an outer wall of the grinding and outlet tube.

16. The grinder of claim 12, wherein the grinder is made of a total of two parts.

17. The grinder of claim 12, wherein the grinder is made of a total of three parts.

18. The grinder of claim 12, wherein the grinder is made of three or fewer parts.

19. The grinder of claim 12, wherein the junction comprises a sharp 90 degree edge.

20. The grinder of claim 19, wherein the junction comprises a sharp-edged projection that extends into a hollow of the tubular inlet.
